(19) United States
(12) Patent Application Publication
(10) Pub. No.: US 2010/0220972 A1
(43) Pub. Date: Sep. 2, 2010

(54) PRESENCE AND PROXIMITY RESPONSIVE PROGRAM DISPLAY

(76) Inventor: David Alan Bryan, Carmel, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/719,384

(22) Filed: Mar. 8, 2010

Related U.S. Application Data
(62) Division of application No. 11/200,282, filed on Aug. 8, 2005.

(51) Int. Cl. H04N 5/91

(52) U.S. Cl. 386/66; 386/68; 386/E05.003

(57) ABSTRACT

Certain digital technology based consumer media devices such as personal video recorders have the ability to find and watch television shows, and/or automatically record programs of interest. The present disclosure provides systems and methods that allow a user to control the display, pausing or recording of programs based on the user's presence in, or proximity to, a program viewing area. Also disclosed are methods for controlling program display based on a priority or rank assigned to the users. The disclosed methods also allow users to control the programs that certain individuals see or hear, and in particular minor children.

### FIELD OF THE INVENTION

The present disclosure relates to the display, pausing or recording of programs based on a user's presence in, or proximity to, a program viewing area. The methods and systems disclosed herein provide users with the capability to move freely about a household while still being able to view the desired portions of their programs of interest.

### BACKGROUND

Due to their flexibility, advanced capabilities, and ease-of-use, digital technology based consumer media devices, such as set-top boxes for cable and satellite television, or Personal Computers (PCs) with television receiving and recording functionality, have begun to provide an alternative to the traditional television and Video Cassette Recorder (VCR) as means for viewing and recording television programs in the home. These devices provide the ability to view and record programs of interest, both through user commands and programming as well as by “learning” user likes and dislikes, i.e., a user's program preferences. Users can select programs based on title, channel, time of airing, as well as by favorite actor, actress, director, or through the use of other specific parameters.

In spite of these powerful features, current digital consumer devices are limited, in that users frequently find that they have missed programming of interest to them, or portions of the programs, if they forget to explicitly instruct the device to record or pause the program whenever they have to leave the room. As an example, users can find that they missed the most exciting portion of a televised sports broadcast if they go for a refreshment break. While some media devices allow the user to “rewind” to the interesting portions of the program they missed, this is an extra step that the user has to perform upon returning to the room.

For the foregoing reasons, there is a need for methods and systems that enable a user to control the display, pausing or recording of programs based on the presence and/or proximity of the user. The systems and methods of the present disclosure provide users with the capability to move freely about a household without fear of missing any portion their programs of interest, in many cases without need for explicit action from the user.

### SUMMARY

In a first embodiment, the present disclosure provides a method for displaying a program depending on a user's presence within a program viewing area. The method includes the step of determining if a user is present within a program viewing area. If a user is present, then the user is identified and the program preference of the identified user is displayed. If no user is present, then a pre-selected program is paused or recorded. The present disclosure also provides a method for displaying a program depending on the rank of one or more users present within a program viewing area. The method includes the steps of detecting the presence of one or more users in a program viewing area, determining the rank of the one or more users, and displaying a program preference of the user with the highest rank. In yet another embodiment, a method for displaying a program depending on the presence of a user within a program viewing area is also provided. The method includes the steps of detecting the presence of one or more users within a program viewing area, and determining if one or more of the users is a super-user. If a super-user is detected, then the super-user program preference is displayed. If no super-user is detected, then the super-user program preference is paused or recorded.

In another embodiment, the present disclosure provides a method for displaying a program depending on user presence within a program viewing area. The method comprises providing first and second program viewing areas; detecting the presence of a user within the first program viewing area; identifying the user; detecting the presence of the identified user within a second viewing area; and displaying a program preference of the identified user in the second viewing area, wherein the program preference is displayed from a re-start point, and wherein the re-start point is the time point within the program preference at which the user is no longer detected within the first program viewing area.

In a specific embodiment, the present disclosure provides a method for displaying a program depending on the presence of a child in a program viewing area. The method includes the steps of determining if a child is present within a program viewing area, and displaying a child-friendly program if a child is present.

In other embodiments, the disclosure provides a method for displaying program choices on the user interface of a personal video recorder. The method includes the steps of determining if a user is present within a program viewing area, identifying the user present, and displaying the program preferences of the identified user on the user interface of a personal video recorder. In another embodiment, the method includes the steps of detecting the presence of one or more users in a program viewing area, determining the rank of the one or more users, and displaying the program preferences of the user with the highest rank on the user interface of a personal video recorder.

The present disclosure also provides a personal video recorder including a personal video recording unit for viewing and recording programs, a remote control unit, including at least one key for sending viewer preference commands to the personal video recording unit, and a sensor unit for detecting the presence of one or more users within a program viewing area. In another embodiment, the present disclosure provides a personal video recorder including a personal video recording unit for recording programs and playing back previously recorded programs, a memory device for storing content therein, a sensor unit for detecting the presence of one or more users within a program viewing area, and a processing unit for adjusting playback of the personal video recording unit based on information related to one or more users, wherein the playback is adjusted to provide content stored in the memory device.

In another embodiment, the disclosure provides a memory for access by a processor having a data structure for a media program reference stored in the memory, the data structure having interrelated data types, wherein instruction signals embody the data structure, and wherein the interrelated data types include data types to store information. The memory includes a media program identifier; a channel identifier for media programs, wherein the channel identifier identifies a media source by which the media program identified by the media program identifier may be accessed; an available access time identifier for a media program referenced by the media program identifier; a schedule resolver identifier, wherein a media source and available access time for the media program identifier may be resolved to alternative media sources and access times should the media program identifier become inaccessible based on the invalidity of identifiers in the media program reference; and a user identifier, wherein the user identifier identifies a program preference of one or more users detected within a program viewing area.

These and other features of the disclosed systems and methods will be more fully understood from the following detailed description of the embodiments, which should be read in light of the accompanying drawings.

In this respect, before explaining the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims contemplate such equivalent constructions that are in the spirit and scope of the present invention.

### BRIEF DESCRIPTION OF THE DRAWINGS

The accompanying drawings, which are incorporated in and form a part of the specification, illustrate embodiments of the present invention and, together with the description, serve to explain the principles of the invention;

FIG. 1 illustrates a PVR installed in a scenario;

FIG. 2 illustrates a PVR that is connected to a network or the Internet, either directly, or through a secondary device;

FIG. 3 shows a block diagram of an exemplary PVR;

FIG. 4 illustrates a group of PVRs and a central server that are connected to a network;

FIG. 5 illustrates a PVR, a sensor, and the program viewing area associated with the PVR;

FIG. 6 is a flow chart showing an embodiment where a user's program preference is displayed, paused or recorded depending on the detection and identification of the user;

FIG. 7 is a flow chart showing an embodiment where a program preference is displayed, paused or recorded depending on the rank of the identified user;

FIG. 8 is a flow chart showing an embodiment where a super-user's program preference is displayed, paused or recorded depending on the presence of the super-user.

### DETAILED DESCRIPTION OF THE PREFERRED EMBODIMENTS OF THE INVENTION

In describing an embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

The present disclosure provides methods for displaying a program that are responsive to the presence and/or proximity of one or more program viewers. In particular, the disclosure provides methods for displaying a viewer's program preference, if the viewer is present within a program viewing area, or pausing or recording the program, if the viewer is absent from the program viewing area. The present disclosure also provides systems capable of displaying, pausing or recording programs depending on the presence of the viewer within the program viewing area. For example, a personal video recorder may be paused when a viewer leaves a room, with no explicit action by the viewer.

Systems on which the methods disclosed herein can be performed include digital technology-based consumer devices such as personal video recorders (PVRs) and personal computers with PVR functionality. In this description, a personal video recorder or PVR, can refer to the traditional units available from, for example, TiVo, Inc. of Alviso, Calif. and ReplayTV (Digital Networks North America, Inc) of Santa Clara, Calif., or any other digital technology-based consumer media device, such as set-top boxes for cable and satellite television with recording capabilities, DVD Recorders, Personal Computers (PCs) with television receiving and recording functionality, Personal Digital Assistants (PDAs) with video playback abilities, Personal/Portable/Digital Video Player/Recorders (PVPs, DVPs, PVRs, DVRs). Furthermore, the various embodiments described below are not restricted to video media, but rather could also be applied to other forms of media, e.g., audio media.

### Exemplary Systems For Program Display

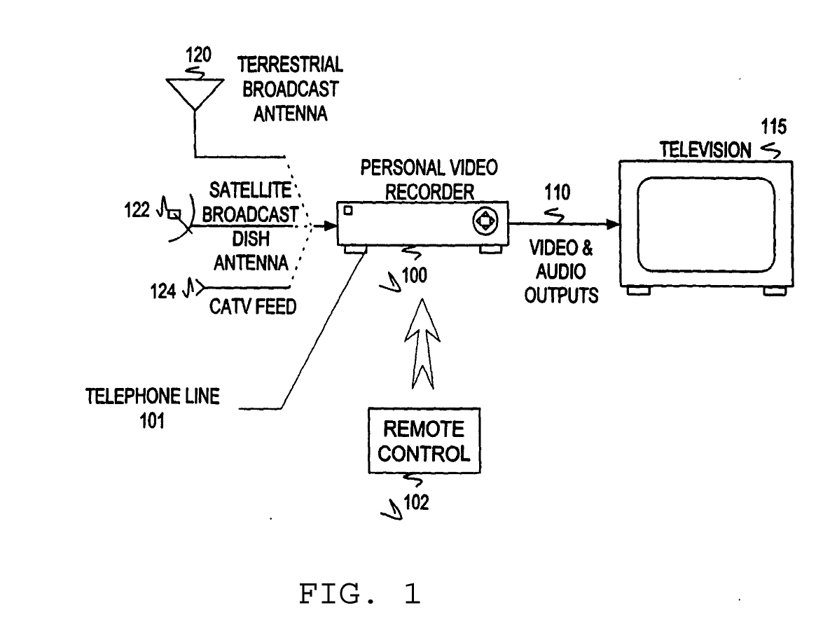

FIG. 1 shows a PVR installation. Personal Video Recorder 100 receives a broadcast signal from one or more program sources. The sources of programs may include terrestrial broadcast, satellite broadcast, and cable television (CATV). These program sources are received respectively by a Terrestrial Broadcast Antenna 120, a Satellite Broadcast Dish Antenna 122, and a CATV Feed 124. A program source can comprise analog, digital or a combination of analog and digital programs. Video and Audio outputs 110 of Personal Video Recorder 100 are connected to Television 115 for user viewing of programs from Personal Video Recorder 100. Video and Audio outputs 110 may also be connected to another auxiliary device, such as a conventional videocassette recorder or digital video disc recorder. In addition, the audio outputs may be connected to speakers (not shown) that are remote and separate from the Television 115.

The user controls the Personal Video Recorder 100 using Remote Control 102. Standard controllable functions may includes: changing channels; muting and adjusting the sound volume; pausing, fast forwarding and rewinding through programs; setting up the PVR to record programs; and selecting previously recorded programs for viewing.

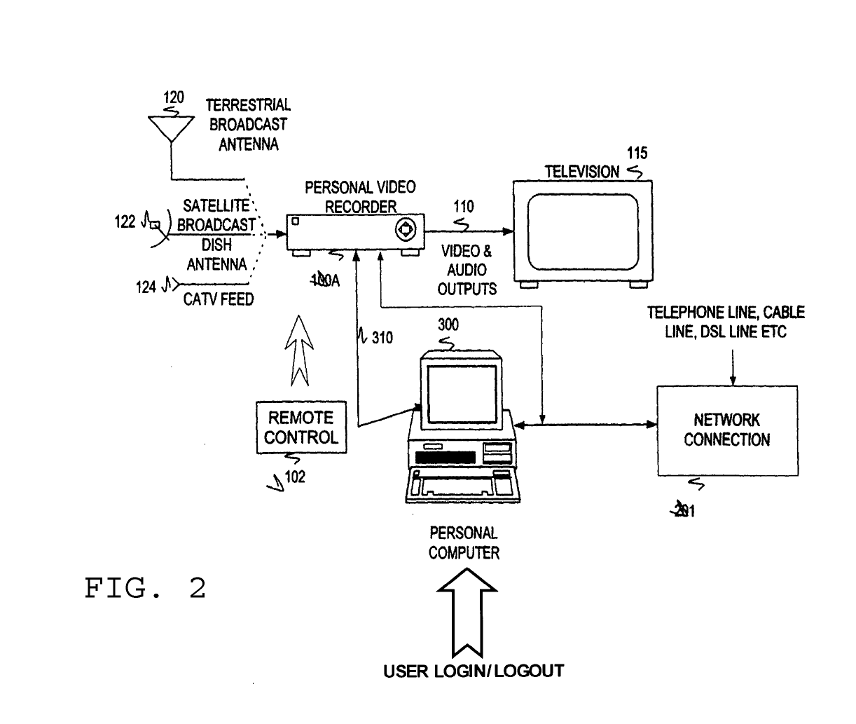

Standard PVRs include a telephone line modem (not shown) or network interface (e.g., an Ethernet port for broadband Internet connectivity) to allow the PVR to download program guide information and the like. The functionality of a PVR may be further enhanced by connecting it to the Internet to enable it to exchange information with other devices at remote sites, as discussed in more detail below. In one embodiment, the PVR itself is an Internet device, i.e., it incorporates a module (such as cable modem, WiFi adapter, etc.) that provides a direct Internet connection. FIG. 2 shows the connection of Personal Video Recorder 100A directly to the Internet through a network connection 201. Alternatively, as shown in FIG. 2, the Personal Video Recorder 100A is connected to an external Internet access device such as a personal computer 300 which is, in turn, connected to the Internet through network connection 201 and transmits information between the PVR 100A and other remote devices.

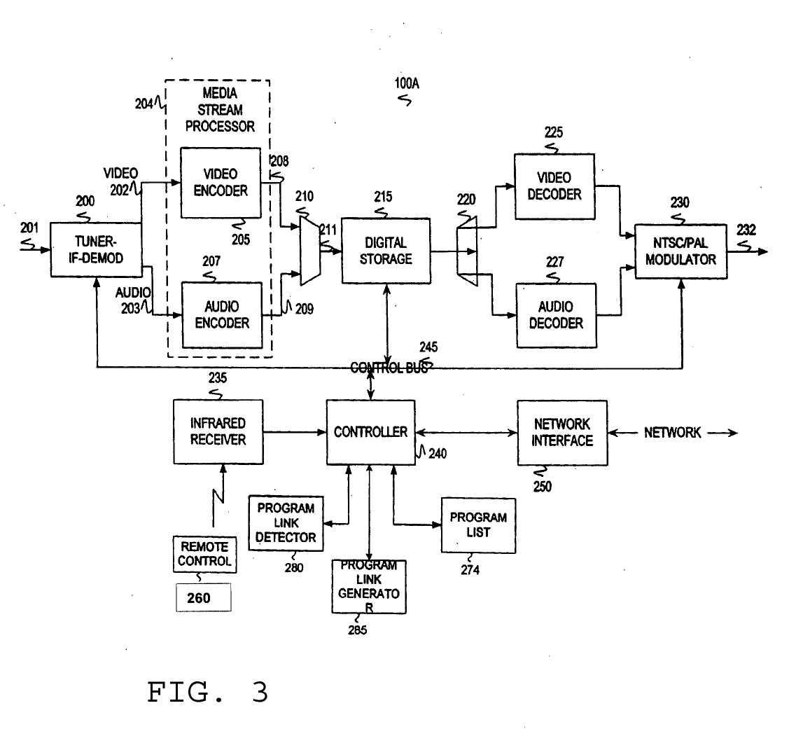

FIG. 3 is a simplified functional block diagram of Personal Video Recorder 100A. The particular PVR illustrated in FIG. 3 is for use with analog television broadcasts (over-the-air or CATV, for example). The antenna/cable feed 201 is input to Tuner-IF-Demod 200. Tuner-IF-Demod 200 is the combined functionality of tuner, intermediate frequency (IF) processing, and demodulator. (References in this specification to a “tuner”, are typically to the Tuner-IF-Demod combination; however, other tuners are available in the art can be used.) These functions serve to tune the selected channel, filter and mix the selected channel to baseband, and demodulate the received signal into a video signal 202 and audio signal 203. The channel is selected by the user through an IR (infrared) remote control 260 through Infrared Receiver 235 and Controller 240.

Controller 240 programs the channel in Tuner-IF-Demod 200 through a Control Bus 245.

Video signals 202 and audio signals 203 are processed by Media Stream Processor 204, which includes Video Encoder 205 and Audio Encoder 207. Video Encoder 205 digitizes (converts from analog form into digital form) and compresses video signals 202. Video Encoder 205 may use one of the many video compression algorithms such as those included in the standards commonly known as MPEG-1, MPEG-2, or MPEG-4, or a proprietary algorithm. Audio Encoder 207 digitizes and compresses audio signal 203. Audio Encoder 207 may use one of the many audio compression algorithms such as those included in the standards commonly known as MPEG-1 (including the algorithm commonly called MP3), MPEG-2, or MPEG-4, or another algorithm. Video Encoder 205 and Audio Encoder 207 may also encrypt the media streams to protect them from unauthorized copying. The digitized video and audio signals 208 and 209 are multiplexed in multiplexer 210 and the multiplexed signal 211 is stored in a file on Digital Storage 215 under the control of Controller 240 through Control Bus 245. Digital Storage 215 may be any fixed or removable mass storage device, including a hard disk drive, an optical disk drive, flash memory, etc.

Playback comprises retrieving of a desired media file from Digital Storage 215, and demultiplexing the retrieved signals in demultiplexer 220. The demultiplexed video and audio signals are decoded by Video Decoder 225 and Audio Decoder 227. Video Decoder 225 and Audio Decoder 227 use the appropriate decompression algorithms based on those used in Video Encoder 205 and Audio Encoder 207. Video Decoder 225 and Audio Decoder 227 may also decrypt the media signals if they were encrypted during the encoding process. The outputs of Video Decoder 225 and Audio Decoder 227 are converted to a form that is appropriate for display on Television 115 by NTSC/PAL Modulator 230. The output signals 232 of NTSC/PAL Modulator 230 may include an RF modulated composite video and audio signal as well as separate video and audio signals. Separate video signals may include a baseband composite video signal, an S-Video signal, and a component video signal. Audio signals may include line level analog mono or stereo audio and S/PDIF digital audio signals. In one embodiment, a high-definition (HD) tuner and receiver are used, in which case the transmissions do not need to be digitized as they are already digitally encoded.

Controller 240 is responsible for managing all of the functions of Personal Video Recorder 100A and is also responsible for managing the files on Digital Storage 215. Included in the management of the files is the monitoring of free storage space, removal of unused or unneeded files, and prioritization of storage operations. Controller 240 is also responsible for acquiring, formatting and displaying an Electronic Program Guide (EPG) on television 115. Controller 240 may acquire the data required for the EPG from information carried on the broadcast signal or by downloading data through Network Interface 250 as discussed above. The Network Interface 250 is implemented either through a telephone modem, or as a direct or indirect Internet connection as illustrated in FIG. 2.

The EPG displays a listing of current and upcoming programs on all of the available channels. The user navigates the EPG, searches for programs, and selects programs to view or record by using an IR remote control 260 through Infrared Receiver 235.

Referring again to FIG. 3, Digital Storage 215 has a read/write bandwidth that is sufficient to effectively support simultaneous read and write operations. This allows a user, for example, to watch a previously recorded program while another program is being recoded or paused. In some embodiments, the PVR is capable of recording or pausing two programs while the user is watching a different program or a previously recorded program, as discussed in greater detail below.

Playback from Digital Storage 215 may be prompted by a request from the user. The user makes a playback request through an on-screen catalog of recorded programs.

In one embodiment, when a PVR user watches a television show, he/she creates information regarding his/her interest level in the show. In a specific embodiment, remote control 260 is provided with a set of standard keys for generating standard commands, such as record, pause, play, replay, fast-forward, etc. In addition, remote control 260 may also include several keys provided for the selection of tags, e.g., the remote control 260 may include a ‘COLD’ key, a ‘HOT’ key, a ‘READ’, an ‘ENABLE HOT/COLD’ key, an “IMPORT TAGS’ and an ‘EXPORT TAGS’ key., as explained in greater detail in co-pending U.S. patent application Ser. No. 10/990,206. The PVR 100A may also include a tag file generator. On some PVRs, “Thumbs-Up” and “Thumb-Down” keys may be provided on remote control 260 to enable the user to indicate their opinion of, or interest level in, a particular show. In one embodiment, these keys may used to indicate Hot-Spots (Thumbs-Up) and Cold-Spots (Thumbs-Down) for a show or for segments within the show. The interest level information provided may be used to assign a user's rank for watching a program in a program viewing location, as discussed in greater detail below.

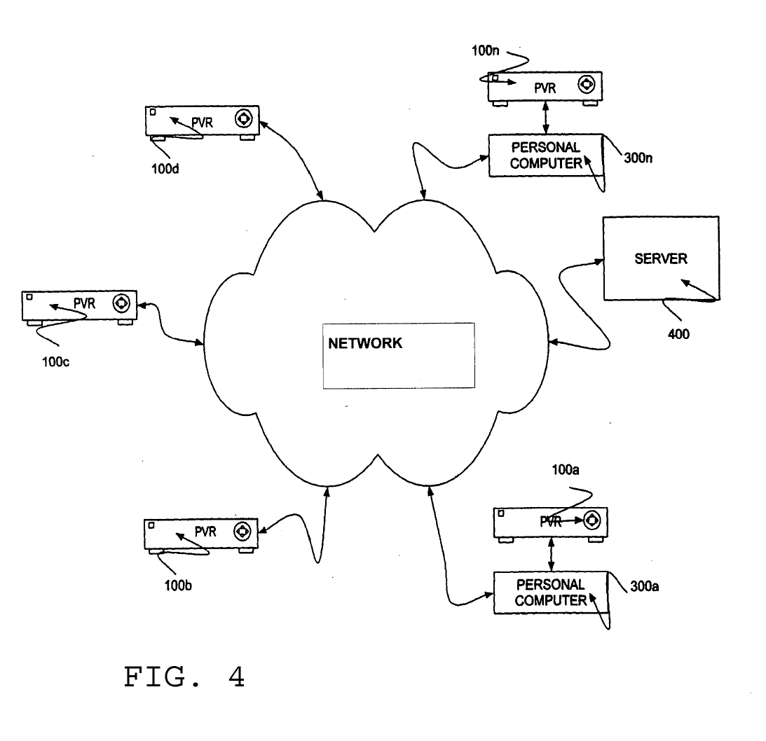

The information about a user and the user's program preferences can be shared by friends and relatives or using various peer-to-peer networks. As shown in FIG. 4, a plurality of PVRs 100a, 100b, 100c . . . 100n (with or without a personal computer, such as 300n) are interconnected by a distributed computer network such as an Internet, the World Wide Web, a local area network (LAN) or a wide area network (WAN). The PVRs share information about a user's identification, priority, and program preferences, as discussed in further detail below. Alternatively, or in addition, a central server 400 may be provided that collects and organizes the information about the user's identification, priority, and program preferences.

Information about users and each user's program preferences can be communicated to a PVR by a variety of other methods and mechanisms. See also co-pending applications U.S. patent application Ser. No. 10/990,223 and U.S. patent application Ser. No. 10/990,206, which are incorporated herein by reference in their entireties, including drawings.

In one embodiment, the user's PVR runs a web server and is attached to their home network, which is accessible over a communications network. In such an embodiment, the user engages the program link and their browser would contact the PVR. The PVR would be known to the user's computer by way of a preference setting (e.g., by providing an IP address for the PVR) and therefore the user would not have to re-enter the PVR address every time they engage a program link. In another embodiment, the PVR is provided with its own email address and is capable of reading emails. In such an embodiment, engaging a program link generates an email addressed to the users' PVR and results in program scheduling.

In another embodiment, each PVR is allocated a network address (such as an IP address) which is long-lived or permanent. In such an implementation, the recipient PVR can be identified by its IP address and a server task can execute on the PVR to listen for and receive incoming programming links. As a variation, each PVR can be identified by a symbolic identifier (such as a hierarchical domain name in the Domain Name System). The network address of a PVR can be resolved based on its symbolic name using a name service, which may take the form of a centralized server, a system of replicated servers, or as a more concrete example, a system of DNS servers.

If PVRs do not have long-lived network addresses, other means of communicating programming links are still possible. In one implementation, each PVR is identified by a symbolic identifier. A name service (which may be implemented in many ways, including, among others, centralized, replicated, distributed) is used to resolve the symbolic identifiers into network addresses. Each time the network address of a PVR changes, the PVR will report its new network address to the name service, thus keeping the latter up-to-date. Such a system will function like dynamic DNS or certain instant messaging (IM) systems.

In another embodiment, a server or a system of servers with sufficiently high availability can be used to receive programming links on behalf of PVRs. Each PVR will periodically connect to one or more such servers to retrieve programming links addressed to it. Such a system can function like an email system. In fact, an email system can be adapted for such purpose. In such an implementation, a PVR will function as a client to one or more email servers.

As an aspect of possible implementations, each PVR is associated with a unique or almost certainly unique identifier. A unique identifier may be derived from, for example, the MAC address of the Ethernet interface of the PVR, if Ethernet is used for networking purposes. Likewise, a unique identifier may be derived from unique identifiers that are allocated or generated for other purposes, such as the combination of model and serial numbers of the PVR itself. Almost certainly unique identifiers can be locally generated based on random locally available sources of randomness. So long as the identifier is long enough and a sufficient amount of entropy is sampled, the resulting identifier can be made practically unique. The analysis of the required amount of entropy and the probability of generating a non-unique identifier is well understood and requires only elementary skills in probability theory.

In an embodiment with a centralized server approach, clicking a programming link, e.g., on the web page of a chat room, may initiate contact with a server at a well-known address. That server may contact the machine of the user who initiated contact with the server to retrieve a cookie which contains a unique identifier of that user's PVR. Any of the above techniques may then be used to resolve the address of that user's PVR. It is also possible to route links to a user's PVR without the involvement of a centralized server, as described below.

As yet another way of routing a programming link to a PVR, PVRs can be arranged in a peer-to-peer (P2P) network, in which each PVR is in direct communication with a small number of other PVRs. The PVR with a given locally unique identifier can be located and contacted using broadcast-based searching in the prior art.

For example, the file-sharing programs have completely decentralized and distributed architectures, meaning that there are no central servers and that all computations and interactions happen between clients. All connections on the network are equal. When a client wishes to connect to the network (s)he runs through a list of nodes that are most likely to be up or take a list from a website and then connect to however many nodes they want. This produces a random unstructured network topology. Routing in the network is accomplished through broadcasting. When a search request arrives into a client that client searches itself for the file and broadcasts the request to all its other connections. Broadcasts are cut off by a time to live that specifies how many hops they may cover before clients should drop them rather than broadcast them. Searching on a decentralized network is accomplished by creating a keyword string that describes the file you want and broadcasting that string to all your connected neighbors. Your neighbors will then in turn broadcast that message to all their connected neighbors and so on until the packet's TTL has been reached.

Another architecture follows a 2-tier system in which the first tier consists of fast connections to the network (Cable/DSL and up) and the second tier consists of slower connections to the network (modem and slower). Clients on the first tier are known as SuperNodes and clients on the second tier are known as Nodes. Upon connection to the network what happens is that the client decides whether you are suitable to become a SuperNode or not. If you can become a SuperNode, you connect to other SuperNodes and start taking connections from ordinary Nodes. If you become a Node you find a SuperNode that will allow you to connect to them and connect. Routing on a 2-tier P2P network is accomplished by broadcasting between the SuperNodes. For example, when a Node issues a search request to the SuperNode it is connected to, the search request is taken by that SuperNode and then broadcast to all the SuperNodes with which it is communicating. The search continues in this way until its time-to-live (TTL) has reached zero. Every SuperNode that it reaches searches an index that contains all the files of its connected Nodes. Replies are routed back along the path that they came from until they reach the clients that originally issued them. A possible problem with this type of routing is that clients making up the backbone may connect and disconnect sporadically, which means that it may not always be possible to route packets back along the path that they came from.

### Presence- And Proximity Responsive Program Display

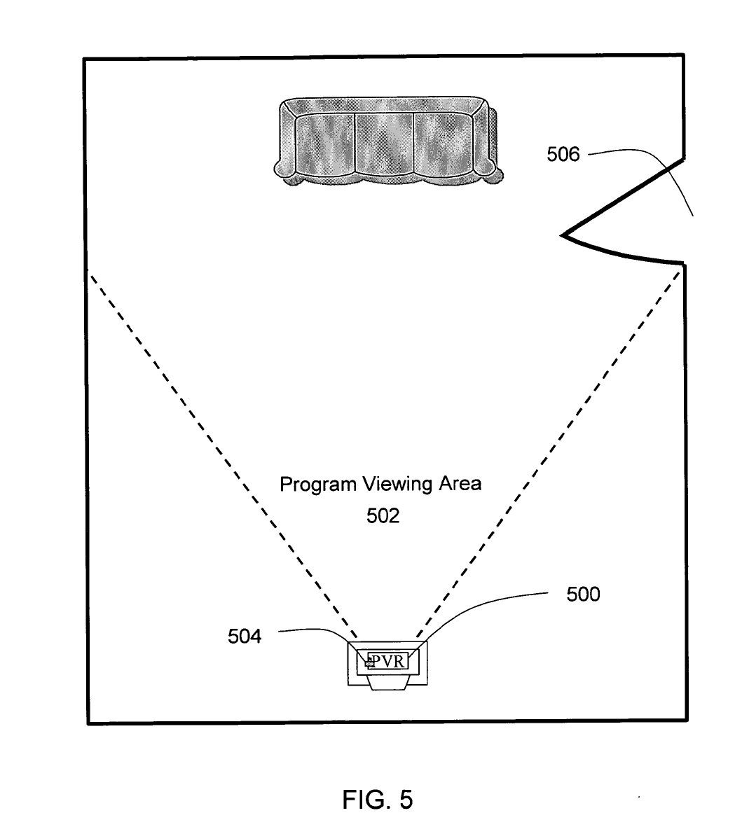

In all embodiments, the PVR includes, or communicates with, means for detecting the presence of one or more users within a program viewing area. References herein to “detecting” the presence of a user also refers to “determining” if a user is present. FIG. 5 illustrates a program viewing area 502 associated with PVR 500. In the illustration of FIG. 5, the program viewing area 502 includes the entryway 506 to the room. However, in different embodiments, and depending on the means chosen for detecting the user(s), the size and borders of the program viewing area 502 will vary.

The means for detecting the presence of one or more users within the program viewing area may be an explicit means, such as user logins/logouts, a camera, radio frequency identification (RFID) or global positioning system (GPS) associated with the user. The camera may be used along with camera image-processing hardware and/or software, as is known in the art. Alternatively, the means for detecting the presence of one or more users may be by implicit means, such as keystroke patterns, program viewing choices or other equivalent means known in the art.

Preferably, the detection means travels with the user, such as RFID tags or the equivalent. Radio frequency identification provides a method of remotely storing and retrieving data using devices called RFID tags and transponders. An RFID tag is a small object, such as a sticker, that can be attached to a user. The RFID tags contain antennas that enable them to receive and respond to radio-frequency queries from an RFID transceiver.

FIG. 5 illustrates an embodiment including a sensor 504 for detecting the presence or proximity of one or more users in the program viewing area. The sensor may be a separate unit that communicates with the PVR, or the sensor may be an integral part of the PVR. For example, in an embodiment including an RFID transponder, the transponder may be integrated into the PVR. Alternatively, the RFID transponder may be a separate unit that communicates with the PVR by means known in the art. References to the detection and/or identification of one or more users in the present specification encompasses both scenarios, i.e., where the detection means is an integral part of the PVR and where the detection means is separate from, but communicates with, the PVR.

In embodiments including more than one user, the PVR is also capable of distinguishing among multiple users who are present simultaneously. Techniques for distinguishing among multiple users are known in the art.

In the different embodiments, the step of detecting the one or more users is repeated periodically. For example, the step of detecting the presence or proximity of the one or more users may be automatically repeated at real-time or at near-real-time. Alternatively, the user(s) may program the sensor to perform the step of detecting at regular intervals of time, such as every 10 seconds, 20 seconds, 30 seconds, 40 seconds, 50 seconds, 1 minute, 2 minutes or higher. In some embodiments, the step of detecting may be repeated periodically after 5 minutes, 10 minutes or even after 30 minutes or longer. The cycle for detection can be programmable by the PVR or sensor manufacturer, or set by one or more of the users.

### User-Responsive Program Display

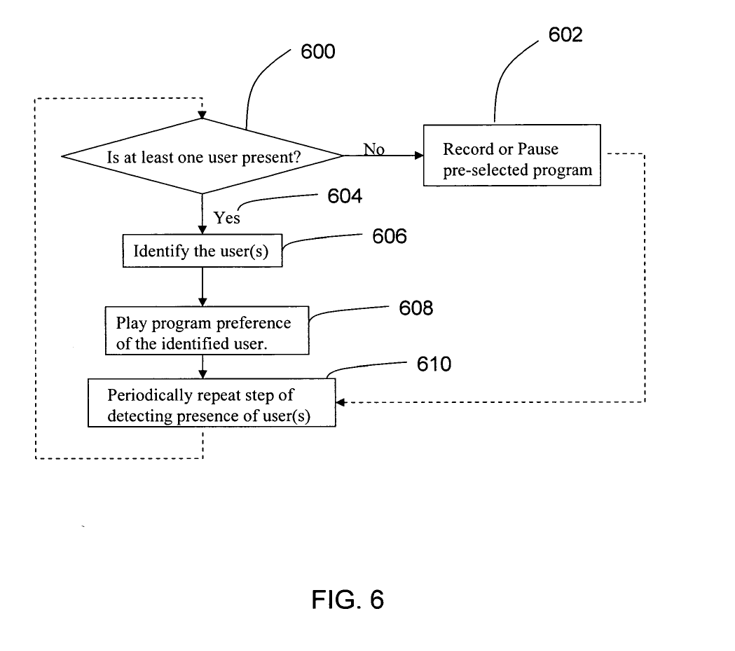

FIG. 6 is a flow chart illustrating an embodiment where a user's program preference is displayed, paused or recorded depending on the presence of the user. In preferred embodiments, a sensor associated with a PVR determines if at least one user is present 600 by means known in the art, such as those described above.

If no user is detected within the program viewing area, the PVR records or pauses a pre-selected program until at least one user is detected 602. The pre-selected program may be the program that had been playing while a user was previously detected in the television area. For example, the PVR detects that the user(s) has left the viewing area, and pauses or records the currently playing program until the user (or users) is once again detected within the program viewing area 502. Alternatively, the pre-selected program may be a program previously selected by a user to be paused or recorded if no user is present within the program viewing area. In other embodiments, the pre-selected program is the program most frequently watched by a user. The exact behavior of the PVR can be programmable by the manufacturer or the user. In a specific embodiment, any cold spots in the pre-selected program that occur within the pause or record time are deleted. See co-pending U.S. patent application Ser. No. 10/990,206 for a detailed description of cold spots, such as program portions that may be uninteresting to the user based on tags generated by other viewers.

If a user is detected 604 within the program viewing area, then an identifier associated with the PVR identifies the user 606. The identifier may be the sensor, or other means known in the art. The PVR plays the program preference of the identified user 608. If the identified user had been in the program viewing area previously, then the program preference is the pre-selected program that the identified user had been viewing. Alternatively, the PVR displays a program preference that the identified user specifies. In yet another embodiment, the PVR includes means for storing information on program preferences of the identified user, and plays the program preference of the identified user based on the stored information, preferably without need for user intervention. For example, the program preference of the identified user is the program most frequently watched by the identified user.

As shown in FIG. 6, the step of detecting the one or more users may be repeated periodically 610, as previously described in connection with other embodiments.

In another embodiment, in a house with multiple PVRs in different viewing locations, the program displayed, paused or recorded may be responsive to the movements of one or more users among the different viewing locations. This feature may be helpful, for example, to allow users to move around a house without missing portions of programming that occur during transit time between viewing locations. In an “island” version of this embodiment, an identified user specifies the re-start point from which the PVR displays the program preference upon reaching another viewing location, i.e., the identified user manually returns the PVR program display to the point at which he/she had stopped viewing the program at the previous viewing location. In a networked version, the PVR at the new viewing location is able to communicate with the PVR at the previous viewing location, or a third device such as a PC in communication with both PVRs, to determine the re-start point from which to play the identified user's program preference. In one embodiment, the re-start point is the time point within the program preference at which the user left the program viewing area at the previous viewing location. In another embodiment, the re-start point in the program preference is beyond a cold spot in the program.

Preferably, all PVRs in the household monitor the program preferences being viewed at all other PVR viewing locations within the household. A PVR would then be capable of predictively buffering the program preferences of one or more users in the household, in case one or more of the users decides to travel from one PVR viewing location to another. The user would have the option of rewinding beyond the time point last viewed at the previous PVR viewing location when they enter the new PVR viewing location. In other embodiments, the PVR records a user's program preferences on multiple PVRs in the household, in case the user wishes to view program preferences that are no longer being broadcast, while the user is moving from one PVR viewing location to another. In yet other embodiments, programs are routed to among different PVRs depending on the user most likely to be using a given PVR. Alternatively, program viewing or recording reminders are routed to the identified users to which they apply. In another embodiment, programs are routed to different PVRs based on who sent them, and possibly nearest to the current location of the intended recipient.

In a specific embodiment, the PVR's user interface, such as the EPG, is responsive to the identity of the user present within the program viewing area. For example, the recommendations displayed by the EPG for viewing and/or recording programs may be based upon which users are present, so as to avoid cluttering the EPG display with, e.g., the recommendations for every user in the household. In other embodiments, the PVR is programmed with, or learns, the preferences of its various users, and presents viewing and/or recording choices which are appropriate only to those identified users present.

In other embodiments, the presence of only certain specified user(s) initiates the playing of an invitation to download a video message or program. The specified user(s) has the choice not to display the message or video at a given time, e.g., if there is a need to preserve privacy.

### Program Display Based On User Rank

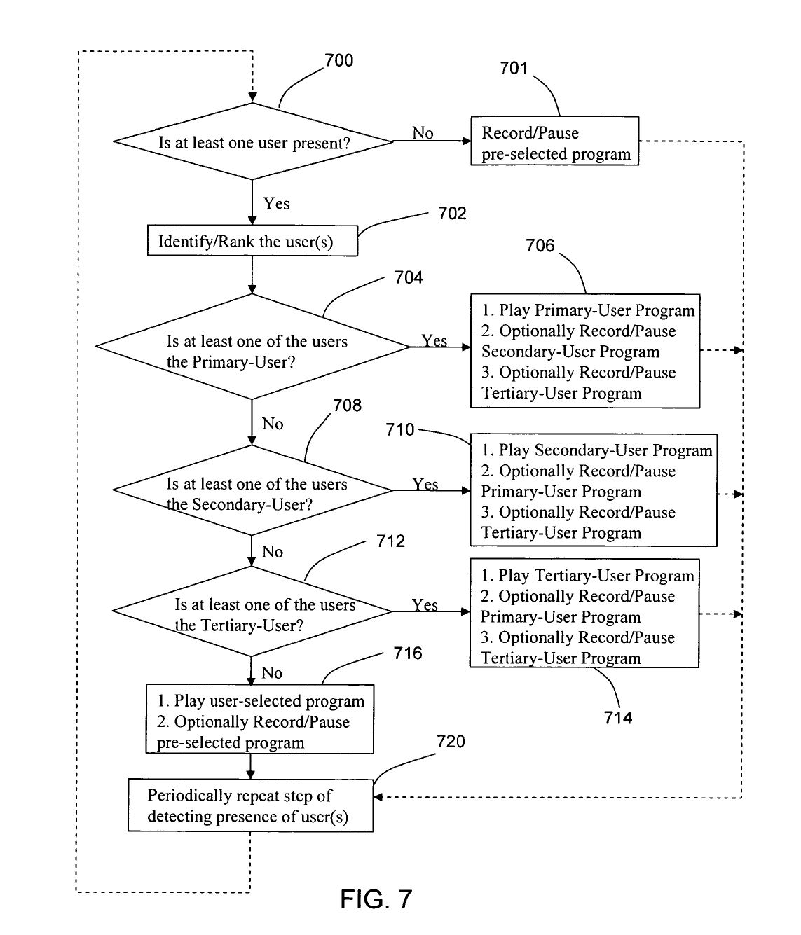

FIG. 7 is a flow chart illustrating an embodiment where a program preference is displayed, paused or recorded depending on the rank of the identified users. In preferred embodiment, a PVR plays, pauses or records different programming depending on which ranked user is present. The method illustrated in FIG. 7 includes the steps of detecting the presence of one or more users within a program viewing area, determining the rank of the one or more users, and displaying the program preference of the user present with the highest rank.

A sensor associated with a PVR determines if at least one user is present 700. If no user is detected, then the PVR pauses or records a pre-selected program 701. The pre-selected program may be a program previously selected by a user to be paused or recorded if no user is present within the program viewing area. Alternatively, the pre-selected program may be the program most frequently watched by a user at that time of day. The exact behavior of the PVR can be programmable by the manufacturer or the user. In a specific embodiment, any cold spots in the pre-selected program that occur within the pause or record time are deleted. The rank of the user(s) detected within the program viewing area may determined by the sensor, or by other means known in the art.

In preferred embodiments, the program displayed, paused or recorded is dependent on a rank, i.e., a priority, assigned to each user. If a user is present, the user is identified and the rank of the user is determined in step 702. In the illustration of FIG. 7, the Primary-User is the highest-ranked user, the Secondary-User has a lower rank, and the Tertiary-User is the lowest-ranked of all three users. In other embodiments, the number of ranked users is greater than three, or less than three. The rank of the users may be pre-assigned. In other embodiments, the rank of the users is assigned based on the frequency of the presence of each user within the particular program viewing area. In related embodiments, the rank of the one or more users in the household changes depending on the time of day. For example, the minor children may be the Primary-Users at a program viewing location during the morning through mid-afternoon to watch cartoons; however, the parents become the Primary-Users at the same location during early evening hours to watch news broadcasts or sports. Additionally, more than one user may be have the same rank. For example, the term Primary-User may refer to two or more users, similarly for Secondary-User and Tertiary-User.

In the embodiment illustrated in FIG. 7, the program displayed is the program preference of the highest-ranked user detected within the program viewing area. If a Primary-User is detected among the users present within the television area 704, then the Primary-User's program preference, i.e., the Primary-User Program is displayed 706. If the PVR has the capability, the program preferences of the Secondary-User and/or the Tertiary-User may also be simultaneously recorded or paused 706, if so specified by the users. If no Primary-User is detected, then the program preference of any Secondary-Users detected within the program viewing area 708, i.e., a Secondary-User Program, is displayed 710. The PVR may optionally record or pause the program preferences of the Primary-User and/or the Tertiary-User 710, as previously specified by the users. If neither a Primary-User nor a Secondary-User is detected within the program viewing area, then a lower-ranked user, such as a Tertiary-User 712, may be identified. In embodiments including a Tertiary-User 712, the PVR displays the Tertiary-User Program 714 if neither a Primary-User nor Secondary-User is detected within the program viewing area. In step 714, the PVR may optionally record or pause either the Primary-User Program, or the Secondary-User Program, or both. If the user detected within the program viewing area has no assigned rank, then the PVR displays the program preference selected by the user 716, and optionally records or pauses a pre-selected program as described above. Furthermore, the pre-selected program may be the program preference of the Primary-User, Tertiary-User and/or Tertiary-User.

The step of detecting 720 is repeated periodically, as previously described in connection with other embodiments.

As described for other embodiments including multiple viewing locations, the program displayed, paused or recorded may be responsive to the movements of the one or more users among different viewing locations. The program preference of the highest-ranked user may be displayed from a re-start point that the user manually specifies, or that is communicated from a PVR at a previous viewing location to the present PVR, or by a third device, such as a PC in communication with both PVRs, as described in connection with other embodiments. The re-start point may be the time point within the user's program preference at which the user left the previous program viewing area or may be beyond a cold spot in the program preference.

In another embodiment, the PVR's user interface, such as the EPG, is responsive to the rank of one or more users present within the viewing area. For example, the recommendations displayed by the EPG for viewing and/or recording may be based upon the identity of the highest-ranked user present, so as to avoid cluttering the EPG display. Such capability can be programmed into the PVR, or can be “learned” by the PVR over time.

In yet another embodiment, the space on a given PVR is conserved by limiting the pausing or recording to those programs that are likely to be of most interest to the highest-ranked user of that PVR. In related embodiments, the highest-ranked user is the most frequent user(s) of the given PVR as a function of the time of day, e.g., the children's morning cartoons as compared to the teenager's late afternoon music videos.

The rank of the users within a household may be assigned based on a “presence history” database, in embodiments where all the PVRs in a household have access to a database, whether maintained centrally or distributed. By maintaining a “presence history” database, the PVRs, or a central “brain” such as a PC networked with the PVRs, are able to predictively buffer programs according to predictions of user movements, and hence rankings. For example, the PVRs may know that dad watches a certain program in the bedroom in the mornings, and then some time later moves to the kitchen. In one variation, the PVR can predict what program to buffer based on the expected location of the users. For example, the PVRs monitor that dad typically makes his way to the kitchen at 7:15 A.M., and may make this his default situation, i.e., assign him the highest rank in this viewing location. In another variation, the PVRs may track users movements in real time to understand what to buffer, and at what times, since people's routines are not completely predictable. For example, two users may be heading towards the same viewing location, and the second user to reach the viewing location may have a higher rank than the first, so the PVR at the destination may be programmed to buffer the program preferred by the second user. On the other hand, even though the higher-ranked user is heading towards the same viewing area as a lower-ranked user, the PVR may be able to predict that the higher priority user will veer off in a different direction, and instead buffer the program preference of the lower-ranked user.

### Child As Highest-Ranked User

In a specific embodiment, the minor child (or children) within the household is assigned the highest rank, i.e., are Primary-Users. This embodiment allows the parent(s) or guardian(s) within the household to restrict the programming that the minor child sees or hears. It is preferable that the program viewing area 502 includes an area near the entrance, or within ear shot of the room 506, as illustrated in FIG. 5.

If the Primary-User, i.e., the minor child or children, is detected within the program viewing area, the PVR automatically displays the Primary-User Program 706. In a specific embodiment, the Primary-User Program 706 is a child-friendly version of the program that the adults had been watching prior to the child being detected. For example, the Primary-User Program 706 may be an edited version of the program, in which the inappropriate content has been edited out, e.g., a “G-rated” or “PG-rated” version. The Primary-User Program may be a tagged version of the program the adults were viewing, where the program advances to a portion of the program that was tagged as child-friendly. Alternatively, the Primary-User Program may be a different program altogether, e.g., a G-rated cartoon. The unedited or untagged version of the program can be simultaneously recorded for later viewing, if so desired. In an embodiment where the Primary-User Program is a tagged version of the program, the PVR may be used to provide a minute or more delay, to insure sufficient time for the presence of the minor child to be detected.

The program viewing area may be limited to the area near a bedroom door 506, so that the inappropriate content is deleted only when someone is about to enter the bedroom. This would serve to reduce the number of “false positives,” i.e., where an inappropriate person, e.g., a minor child or children, is nearby but not within viewing range or earshot.

### Program Display Based On Super-User Presence

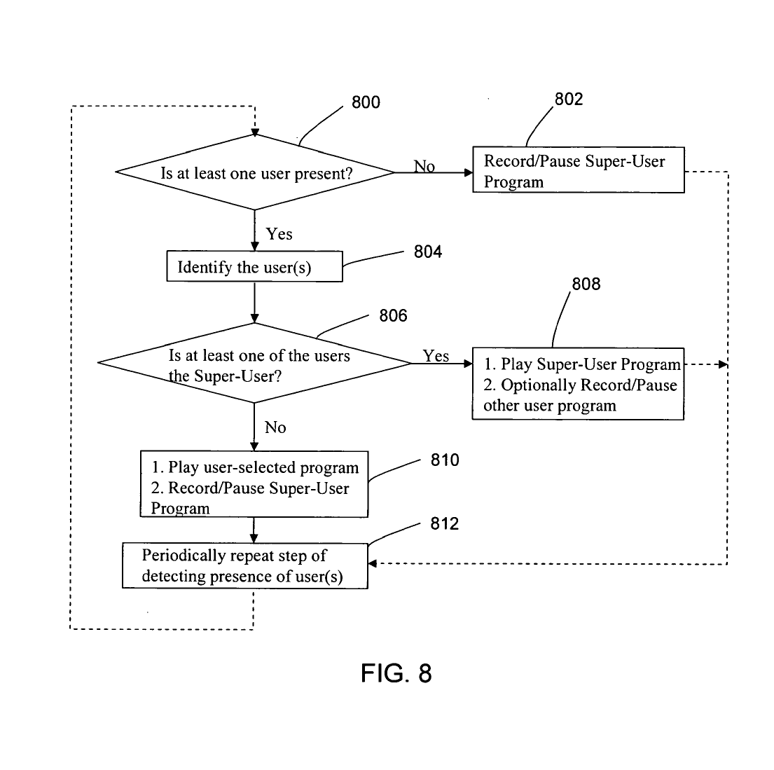

FIG. 8 is a flow chart illustrating an embodiment including a super-user, where the super-user's program preference is displayed, paused or recorded depending on the presence of the super-user. A sensor associated with a PVR determines if at least one user is present 800. If no user is detected, then the program preference of a super-user (described in greater detail below) is paused or recorded 802. If one or more users is detected, then a sensor or an identifier associated with the system identifies the user(s) 804.

The method of FIG. 8 includes the step of determining if one or more of the users is a super-user 806. In this embodiment, the PVR is be responsive to the presence of the super user such that if the super user is present within the program viewing area, then the PVR displays the program preference of the super user 808. The PVR may also records one or more alternative programs 808. If no super-user is detected, then the program preference of the super-user is paused or recorded 810. For example, assume that the PVR is currently displaying the program which is the choice of the super-user. If the super-user leaves the program viewing area, then the PVR displays an alternative program, while pausing or recording the super-user program preference. Upon return of the super-user, the PVR resumes playing the super-user program preference, while recording the alternative program. In another embodiment, a super user may program the pause function to be responsive only to his or her presence. In yet another embodiment, in a house with multiple PVRs in different viewing locations, the program displayed, paused or recorded may be responsive to the movements of one or more users among the different viewing locations, as described in connection with other embodiments.

The step of detecting 812 is repeated periodically, as previously described in connection with other embodiments.

In a specific embodiment, the super-user is a minor child. This embodiment also allows parents and guardians to restrict the programming that minor children see or hear. As described above, the program viewing area 502 may be specified to include an area near the entrance, or within ear shot of the room 506, or may be limited to the area near a bedroom door 506, as illustrated in FIG. 5. If the minor child (or children), is detected within the program viewing area, then the PVR automatically displays the super-user program preference, which may be an edited or tagged version of the program, as described above in connection with other embodiments. The unedited or untagged version of the program may be simultaneously recorded for later viewing, if the adults so desire.

In another embodiment, the super-user may be a pre-determined group containing two or more users. The program display would then be responsive to the presence of the members of the super-user group. The PVR may be programmed to pause when anyone who is a super-user group member leaves the program viewing area, and not resume playing until all member of the super-user group return. Alternatively, a “return timer” may also be provided, such that the PVR resumes playing after some default or programmable time, even if not all members of the super-user group have returned.

In yet another embodiment, the presence of only the super-user initiates the playing of an invitation to download a video message or program. The super-user has the choice not to display the message or video at a given time, e.g., to preserve privacy.

### Alternate Embodiments

In an embodiment, the program recommendations or actual programs to be recorded are routed to a given PVR based on the sender, according to routing instructions by a given user, which can include “route program(s)/(recommendations) from sender X to PVR nearest to me at the current time.” Alternatively, programs from a given sender can always be routed to a given PVR, independent of the given user's presence near that PVR.

In another embodiment, reminders to watch/record a certain program are displayed or spoken by the viewing/recording device according to the user's presence within the viewing area. This embodiment is not limited to PVRs, but rather includes any devices with storage.

In yet another embodiment, video messages intended for certain user(s) are stored on PVRs, and only played when said user(s) are detected within the viewing area. In a variation, said playing may only take place when said user(s) is (are) alone, i.e., no other user is detected. Alternatively, the messages are only stored on one or more PVRs designated by the user. In another variation, the messages are only stored on the PVRs most frequently used by a specific user.

The many features and advantages of the invention are apparent from the detailed specification. Thus, the appended claims are intended to cover features and advantages of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, numerous changes and modifications may be made and are contemplated as being within the spirit and scope of the invention. The invention is intended to be protected broadly within the spirit and scope of the appended claims.

1. A method for displaying a program depending on user presence within a program viewing area, the method comprising:
displaying a program to a user in a first viewing area;
determining a point in time when the user leaves the first viewing area and determining a re-start point in the program, where the restart point corresponds with the point in time when the user leaves the first viewing area;
determining if the user is present within a second program viewing area;
if the user is present within the second program viewing area, identifying the user and displaying the program to the user, where the program is played from the re-start point; and
if no user is present, recording a program based on a user profile for the user.

2. The method of claim 1, wherein the step of determining is repeated periodically.

3. The method of claim 1, wherein the step of displaying further comprises the step of determining a re-start point in the program preference from which to display the program preference.

4. The method of claim 3, wherein the user specifies the re-start point in the program preference.

5. The method of claim 3, wherein the program preference is displayed by a first personal video recorder.

6. The method of claim 5, wherein the first personal video recorder is on a network.

7. The method of claim 6, wherein the re-start point in the program preference is communicated to the first personal video recorder from a second personal video recorder on the network.

8. The method of claim 1, wherein the program preference is the program most frequently watched by the user.

9. The method of claim 1, wherein the presence of the user is determined by user logins, user logouts, a camera, radio frequency identification (RFID) tags, global positioning system (GPS), keystroke patterns or program viewing choices.

10-41. (canceled)

42. A method for displaying a program depending on user presence within a program viewing area, the method comprising:
providing first and second program viewing areas;
detecting the presence of a user within the first program viewing area;
identifying the user;
detecting the presence of the identified user within a second viewing area; and
displaying a program preference of the identified user in the second viewing area, wherein said program preference is displayed from a re-start point, and wherein said re-start point is the time point within the program preference at which the user is no longer detected within the first program viewing area.
